(19) United States
(12) Patent Application Publication
(10) Pub. No.: US 2026/0244466 A1
(43) Pub. Date: Aug. 20, 2026

(54) GEN AI BASED REAL-TIME CO-BROWSE SIMULATOR FOR MOBILE AND ONLNE BANKING CUSTOMERS

(71) Applicant: Bank of America Corporation, Charlotte, NC (US)

(72) Inventors: Nipun Mahajan, Lawrenceville, NJ (US); Amit Mishra, Chennai Tamil Nadu (IN); Sivaramakrishnan Shanmugam, Chennai (IN); Dayanand Kurane, Hafeezpet Hyderabad (IN); Sushama Shelke, Mumbai Maharashtra (IN); Yogesh Raghuvanshi, Pennington, NJ (US)

(21) Appl. No.: 19/055,692

(22) Filed: Feb. 18, 2025

(51) Int. Cl. G06F 9/451; G06F 21/62; G06Q 30/016

(52) U.S. Cl. CPC G06F 9/453; G06F 21/6245; G06Q 30/016; G06F 2221/2113

(57) ABSTRACT

Apparatus and methods for resolving technical support issues encountered when a user uses a digital portal of an enterprise. An AI co-browse agent may conduct a co-browse session with the user to resolve a technical support issue. Each may have a screen that presents a user view and a simulated view of the digital portal. The AI co-browse agent may demonstrate actions in the simulated view that user may replicate in the user view. The AI co-browse agent may mask sensitive information of the user to avoid in advertent disclosure. The AI co-browse agent may include a real-time co-browse simulator that runs using a Gen AI system. The real-time co-browse simulator may synchronize actions of the user with actions of the AI co-browse agent, allowing the latter to demonstrate a step, while the former completes the step, in a coordinated manner until the technical support issue is resolved.

### FIELD OF TECHNOLOGY

Aspects of this disclosure relate to resolving a technical support issue encountered using a digital portal. Specifically, the disclosure relates to resolving a technical support issue encountered using a digital portal by using a synchronized co-browse session.

### BACKGROUND

In technical support scenarios, users may be unwilling to share their screens with agents due to security concerns. Additionally, when seeking help with mobile applications, technical support agents may be working on a desktop or a laptop computer system that may lack access to mobile interfaces, making real-time assistance difficult.

These factors may lead to inefficient troubleshooting. Valuable time of agents may be utilized in troubleshooting issues that may result in long waiting time for other users in the queue. This may lead to agent burnout and poor customer experience.

AI robotic bots typically direct users to an information channel into which the bot lacks visibility. Furthermore, an artificial intelligence (“AI”)-equipped customer assistance digital robot (“bot”) may provide direction to a user but may fail to supervise the user's actions in the channel such as described in U.S. patent application Ser. No. 18/962,898, filed on Nov. 27, 2024, and entitled, “AI Chatbot Co-Browsing”, which is hereby incorporated by reference herein in its entirety.

### SUMMARY

Provided are systems and methods for resolving technical support issues. The technical support issue may arise when a user uses a digital portal to access an account held with an enterprise. The method may include receiving, at the technical support center of the enterprise from the user, a request for a co-browse session, said co-browse session to be conducted between an artificial intelligence (“AI”) co-browse agent and the user to resolve the technical support issue.

The co-browse session may include a first display that is provided to the AI co-browse agent. The first display may include a user view of the digital portal and a simulated view of the user view of the digital portal. The co-browse session may include a second display is provided to the user as a graphical user interface (“GUI”) on the device of the user. The GUI may include the user view of the digital portal and the simulated view of the user view of the digital portal. The AI co-browse agent may have read-write privileges to the simulated view and read-only privileges to the user view. The user may have read-write privileges to the user view and read-only privileges to the simulated view.

The method may include using the AI co-browse agent to determine a sensitivity level for each piece of sensitive information appearing on a screen of a device of the user when the user is logged onto the digital portal to access an account held with the enterprise. The AI co-browse agent may assist with technical support issues received at a technical support center of the enterprise. The AI co-browse agent may obtain a predetermined authorization level for the co-browse agent. The AI co-browse agent may mask pieces of sensitive information that have sensitivity levels that are above the predetermined authorization level for the co-browse agent.

The AI co-browse agent may establish the co-browse session between a user's device and the AI co-browse agent. The AI co-browse agent may demonstrate a series of steps on the first display in the simulated view for the user to take to resolve the technical support issue.

A real-time co-browse simulator may synchronize the actions of the user with actions of the AI co-browse agent. The real-time co-browse simulator may run using generative (“Gen”) AI. The real-time co-browse simulator may be a component of the AI co-browse agent. When the AI co-browse agent demonstrates each step of the series of steps on the first display in the simulated view, the real-time co-browse simulator may ensure that each step of the series of steps appears on the GUI in the simulated view. The real-time co-browse simulator may ensure that the user completes each step of the series of steps on the second display in the user view before a next step is presented to the user on the second display in the simulated view. The real-time co-browse simulator may ensure that as the user completes each step of the series of steps on the second display in the user view, the first display in the user view is automatically updated.

The AI co-browse agent may terminate the co-browse session when the technical support issue is resolved.

The method may further include where movements of the AI co-browse agent and of the user are monitored by document object model (“DOM”). The movement may include scrolling and clicking. The movement information from the DOM may assist the real-time co-browse simulator in synchronizing actions of the user with actions of the AI co-browse agent.

The method may further include where the user presents the technical support issue by phone, by email, or by chatbot. The user's device may include a mobile device or a tablet computer, and the digital portal is a mobile portal. The user's device may include a tablet computer, a laptop computer, or a desktop computer, and the digital portal is an online portal.

The method may further include where, when the screen of the user comprises the GUI and other items, said AI co-browse agent is configured to mask pieces of sensitive information that are found on the GUI and the other items.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram in accordance with the principles of the disclosure;

FIG. 2 shows an illustrative block diagram in accordance with the principles of the disclosure;

FIG. 3 shows an illustrative block diagram in accordance with the principles of the disclosure;

FIG. 4 shows an illustrative block diagram in accordance with the principles of the disclosure;

FIG. 5A shows an illustrative flow diagram in accordance with the principles of the disclosure;

FIG. 5B shows an illustrative flow diagram in accordance with the principles of the disclosure;

FIG. 6 shows an illustrative block diagram in accordance with the principles of the disclosure; and

FIG. 7 shows an illustrative block diagram in accordance with the principles of the disclosure.

### DETAILED DESCRIPTION

A user may encounter a technical issue when using a digital portal of an enterprise. A user may encounter an issue whose solution is dependent on successfully navigating the digital portal. The digital portal may be one that is accessed by a smartphone, tablet computer, laptop computer, or desktop computer. The digital portal encountered when connecting using a desktop computer, laptop computer, or tablet computer may be an online portal while the digital portal encountered when connecting using a smartphone or tablet computer may be a mobile portal.

Technical support may be provided by a technical support center in different ways. Technical support may be provided by a human support agent. Technical support may be provided by a chatbot. A chatbot may include a software program that performs tasks automatically. The chatbot may be configured to provide user support. A chatbot may incorporate artificial intelligence (“AI”) technologies. AI technologies may include machine learning (“ML”) and/or natural language processing (“NLP”). ML and NLP may enable the chatbot to understand and respond to the user like a human would respond. The chatbot may include an AI-powered chatbot. The chatbot may include an AI co-browse agent.

There may be a need to assist a human support agent and/or an AI co-browse agent to better assist a user that is facing an issue when accessing an online portal of the enterprise and/or is facing an issue that requires use of the online portal to solve. Human support agents may grow weary of being ineffective at helping users. This may lead to burnout of the human support agent. When the human support agent and/or AI co-browse agent are ineffective at helping the user, this may lead to poor user experiences and/or user dissatisfaction. There may be a need to assist a user facing an issue when using the digital portal of the enterprise and/or when using the digital portal to solve an issue the user is facing. The user may present their issue as a query for assistance from the technical support center of the enterprise.

A possible solution to help a struggling user when verbal and/or written direction from the technical support center is not sufficient is for the user to share their computer screen with the human agent and/or the AI co-browse agent at the technical support center. A concern that arises is that the user may expose sensitive information when sharing their screen as they expose their screen contents to the technical support center. The human support agent and/or AI co-browse agent may be able to view sensitive information on the user's screen that the former are not entitled to access. The concern for exposure of sensitive information may cause the user to refrain from entering a screen sharing arrangement to avoid exposure of their sensitive information.

Sensitive information of the enterprise may include confidential information. Sensitive information of the enterprise may include data that, if disclosed or compromised, could potentially cause harm to the enterprise. Sensitive information may include financial information such as account numbers and account balances, social security numbers, addresses, other personally identifiable information, confidential business data like trade secrets or strategic plans, and the like.

The sensitivity of each piece of information may be recorded in a database stored at the enterprise. Each piece of information may have a predetermined level of sensitivity assigned to it. All information assigned a level of sensitivity may be considered as sensitive information, albeit, with differing levels of sensitivity. The AI co-browse agent may determine the level of sensitivity of each piece of information on a user's digital portal by looking up the piece of information in the database to determine its predetermined level of sensitivity. The AI co-browse agent may redact and/or mask sensitive information that has a level of sensitivity that is determined from the database lookup to be higher than the AI co-browse agent has permission to view on their real and/or conceptual screen. The AI co-browse agent may track the user's digital portal as new pieces of information enter the digital portal. The AI co-browse agent may automatically determine the level of sensitivity of the new information. The AI co-browse agent may redact and/or mask the new sensitive information that has a level of sensitivity that is determined from the database lookup to be higher than the AI co-browse agent has permission to view and/or project onto their real and/or conceptual screen.

Another possible solution to help a struggling user is for the user to provide remote computer access to the human support agent and/or the AI co-browse agent. This may grant the human support agent and/or the AI co-browse agent the ability to access a user's device from another device. Thus, the human support agent and/or the AI co-browse agent may directly act upon the user's device to make the desired changes and/or fixes. However, the human support agent and/or the AI co-browse agent may be able to view sensitive information on the user's device either from looking at the screen being presented, by navigating to other screens on the digital portal, or by viewing other files on the user's device.

A scenario in which sensitive information of the user may be exposed may include when the user has multiple accounts with the enterprise. The user may seek assistance with just one of these accounts. The human support agent and/or the AI co-browse agent may only have authorization to view the account in question. However, when entering a screen share session with the human support agent and/or the AI co-browse agent, these latter parties may gain access to information that is projected onto the user's screen. Additionally, the human support agent and/or the AI co-browse agent may gain access to the displayed information on the user's digital portal with the enterprise. The user may not have a way to protect sensitive information from being disclosed to the human support agent and/or the AI co-browse agent.

When entering a remote computer access session with the human support agent and/or the AI co-browse agent, these latter parties may gain access to information that is projected onto the user's screen. Additionally, the human support agent and/or the AI co-browse agent may gain access to the displayed information on the user's digital portal with the enterprise, files that are open but not currently displayed, and to closed files. The user may not have a way to protect sensitive information from being disclosed to the human support agent and/or the AI co-browse agent. Access to the last two may be obtained, for example, by the human support agent and/or the AI co-browse agent projecting the currently non-projected files and by opening the currently closed file. These may be done under the pretext of accidental action, but in the meanwhile, the human support agent and/or the AI co-browse agent may obtain a screenshot of the information or capture the information by some other means.

The co-browse session may avoid these concerns. When conducting a co-browse session, the human support agent and/or the AI co-browse agent may be limited to accessing the user view and the simulated view. Furthermore, the user view and the simulated view may be obtained by having the views projected onto both the user's screen and the human support agent and/or the AI co-browse agent's actual or conceptual screen. This avoids the need for the user to share their screen or provide remote computer access to the agent. The concerns of the human support agent and/or the AI co-browse agent viewing other files, whether they are currently open or closed, may be avoided. Additionally, the concern of the human support agent and/or the AI co-browse agent viewing sensitive information on the user's screen may be avoided by redacting and/or masking the sensitive information on the user view and the simulated view. By masking sensitive information, only the pertinent information to which the human support agent and/or the AI co-browse agent is privileged to view may be available for them.

When entering a remote computer access session with the human support agent and/or the AI co-browse agent, these latter parties may gain access to the user's accounts. There may be a need for the human support agent or the AI co-browse agent to provide user support while being limited to access only the account for which the user seeks assistance. Disclosed may be a co-browse session that allows the human support agent or the AI co-browse agent to gain access to a visual representation of the view or views of the user that are necessary for helping while avoiding giving any extra viewing privileges.

The co-browse view may be different than the screen share. The co-browse view may be different than the remote computer access. The co-browse session may include the user and the agent sharing the same view. The agent may include the human support agent. The agent may include the AI co-browse agent. Co-browse may include the user and the agent having the same display. For example, each party may have a display that includes a user view and a simulation view. The user may have read-write privileges to the user view on their display but read-only privileges to the simulation view on their display. The human agent and/or AI co-browse agent may have read-write privileges to the simulation view on their display but read-only privileges to the user view on their display.

The co-browse view that includes the user view with the simulation view may be the only objects visible to the user on the user's screen, or there may be other objects visible to the user on the user's screen in addition to the co-browse view. The co-browse view that includes the user view with the simulation view may be the only objects visible on the human support agent and/or AI co-browse agent's screen, or there may be other objects visible on their screen in addition to the co-browse view. The AI co-browse agent may use an actual screen, or the AI co-browse agent may have a conceptual screen within its programming.

Whether user support is provided by a human support agent or by an AI co-browse agent, user support may be provided through spoken words and/or by written text. The user may have difficulty turning the spoken words and/or written text into actions taken using the online portal that help overcome the obstacle the user is facing. It may be challenging for the user to implement spoken words and/or written text into actions on the online portal to solve the issue they face. There may be a need for the human support agent or the AI co-browse agent to visually show the user how to implement actions on the online portal. Disclosed may be a co-browse session that allows the human support agent or the AI co-browse agent to visually show the user how to implement actions on the online portal.

The online portal available to the human support agent or AI co-browse agent may be different than the online portal available to the user. For example, the human support agent may access the online portal through a desktop computer or laptop computer, and the AI co-browse agent may be programmed to access the online portal as found on a desktop computer or laptop computer, while the user may access the online portal through a smartphone or tablet, or vice versa. The human support agent or AI co-browse agent may have difficulty navigating the user through the issue the latter faces due to the different online portals they are each accessing. There may be a need for a way for the human support agent or the AI co-browse agent to have access to the same online portal as the user is viewing to better guide the user to implement actions on the online portal. Disclosed may be a co-browse session that allows the human support agent or the AI co-browse agent to share the same view of the online portal as the user to guide the user in implementing actions on the online portal.

There may be a need for the human support agent or the AI co-browse agent to have access to the same online portal as the user is viewing while having a way to avoid the former from gaining access to sensitive information of the latter. Disclosed may be a co-browse session that redacts and/or masks sensitive information to which the human support agent and/or the AI co-browse agent does not have permission to view. Disclosed may be a co-browse session that redacts and/or masks sensitive information to which other parties may be able to view on the human support agent's screen and/or on the AI co-browse agent screen sensitive information in which they do not have permission to view.

When a co-browse session is initiated, the human support agent or the AI co-browse agent may guide the user to follow certain steps on the digital portal to address the user's concern. The human support agent or AI co-browse agent may get out of sync with the user, causing the user to fall behind the human support agent or AI co-browse agent by several steps. It may take additional time for the human support agent or AI co-browse agent to backtrack to overlap where the user has progressed. There is a need for a more efficient way to keep the user in sync with the human support agent or AI co-browse agent. Disclosed may be a co-browse session that utilizes a real-time co-browse simulator to keep the user and the human support agent, or the AI co-browse agent synchronized with each other.

Provided are systems and methods for providing a tool for a human support agent and/or an AI co-browse agent to address a user's issue. The user's issue may be something related to the use of the online portal. The user's issue may be something that requires use of the online portal to solve. The tool may enable the human support agent and/or the AI co-browse agent to obtain a co-browse view that compares their view to the user's view, for example, by presenting both views on the same physical or conceptual screen. The AI co-browse agent may include an AI co-browse agent.

Disclosed may be an AI co-browse agent that may establish a co-browse session with a user. The AI co-browse agent may assist a user who is using a mobile portal and/or an online portal. The AI co-browse agent may use a real-time generative AI (“Gen AI) based co-browse simulator to achieve some or all the aforementioned functionalities. This may be referred to as the real-time co-browse simulator. For example, the Gen AI co-browse simulator may facilitate providing the co-browse to either or both parties participating in the co-browse session. This may facilitate providing the user with timely instructions provided by the human support agent and/or the AI co-browse agent.

The Gen AI system may include a type of AI that can create new content, ideas, and/or data. The Gen AI system utilize a generative adversarial network (“GAN”) to run the Gen AI system on the AI Co-browse Agent. GAN may help Gen AI system to create new content like images, text, or audio by leveraging a competitive process between two neural networks, a “generator” and a “discriminator”, to produce increasingly realistic data. A GAN may assist Gen AI system to actualize the latter's AI capabilities.

The co-browse session may redact and/or mask sensitive information of the user from the human support agent and/or AI co-browse agent. The redacting and/or masking of sensitive information may protect user's sensitive information during a co-browse session, during screen sharing, and/or during remote accessing. The co-browse session may allow the user to see simultaneously a view of their online portal and the human support agent and/or AI co-browse agent's view of the user's portal. This may facilitate providing step by step instructions to the user to address their concern by acting on the online portal. Steps may be implemented to keep both parties synchronized with each other. This may enhance the efficacy of the co-browse session, enhance user satisfaction at having their issue resolved, and avoid human support agent's burnout.

The AI co-browse agent may access different systems with portal variations with the help of the real-time co-browse simulator. Portal variations may include a mobile portal and an online portal. This system may allow the AI co-browse agent to handle the various use cases disclosed herein efficiently. In one aspect, use of the AI co-browse agent may eliminate the need to get assistance from human agents.

The AI co-browse agent may generate a real-time simulated version of the user's interface. The real-time simulated version may be created with the assistance of the real-time co-browse similar. In making the simulated version, the AI co-browse agent may address security concerns by masking sensitive user information from being displayed. A human agent may oversee the implementation of one or more AI co-browse agents. The human agent may elect to override the AI co-browse agent. Redacting and/or masking may be implemented to shield sensitive information of the user's from being exposed to the AI co-browse agent and/or the human agent.

Additionally, redacting and/or masking the information on the AI co-browse agent may guard sensitive information from data leakage. Data leakage may include the unintentional exposure of sensitive information where private or confidential information is accidentally released to unauthorized parties due to poor security practices, system misconfigurations, and/or human error. Redacting and/or masking the information on the AI co-browse agent may reduce or limit the risk of exposure of sensitive information even if there is a data leakage event.

This system dynamically adapts to the user's device, such as a desktop computer, laptop computer, tablet computer, or mobile device, and provides context-specific instructions. For example, the co-browse session will match the portal being used by the user, regardless of which device the user is using.

A technical support center may include a real or virtual location where a user can communicate with an agent for technical assistance and support. The user may call the center. When doing so, the user may reach an IVR system or an agent who is human. The user may contact the center by email such as through a “contact us” page on the enterprise's website. The user may contact the center through a chatbot or a live chat. A chatbot may include an automated system such as a computer program that uses artificial intelligence to respond to a user's inquiry. A live chat may involve real-time interaction with a human agent such as a conversation with a person.

The disclosed systems and methods may address the needs of the user for assistance in a secure manner with a solution that guides the user through a co-browse session seamlessly. Disclosed is an AI co-browse agent that reduces and/or eliminates the risk of disclosing the user's sensitive information while addressing the user's technical concern with a co-browse session. A chatbot may include the AI co-browse agent.

The AI co-browse agent may address a request for assistance from a user who is using a mobile portal interface or an online portal interface. The AI co-browser will set up a co-browse session using the appropriate portal interface that complements the portal used by the user. An example of a mobile portal may include a mobile banking portal, and an example of an online portal may be an online banking portal.

The real-time co-browse simulator may allow an AI co-browse agent to share a screen with the user by displaying a simulated view that closely matches, or exactly matches, the view of the user. The user may see a second view on the user's screen that is projected by the AI co-browse agent that is the same or similar to the view of the user. The second view may have sensitive information redacted and/or masked. When the user views even the user's own screen in the co-browse session, sensitive information may be redacted and/or masked. The two views on the user's screen may be equally sized. Alternatively, the user's actual portal interface may be any size desired by the user such as a full screen size while the view projected by the AI Co-browse may be any size desired by the user and/or agent, but a different size than the user's actual portal interface.

The AI co-browse agent may redact and/or mask sensitive information of the user's during the co-browse session. Redacting and/or masking sensitive information may include the sensitive information being removed or masked from the display viewed by the human support agent and/or the user. Redacting and/or masking sensitive information may include the sensitive information being removed or masked from being shared with the AI co-browse agent. The sensitive information may be redacted and/or masked from the AI Co-browser obtaining access. Redacting and/or masking may protect sensitive information from data leakage.

The AI co-browse agent may handle and/or track the resolution of the user's query. The resolution of the query may include an end-to-end query resolution. The AI co-browse agent may address a user's concern from the time when the user begins to be assisted by the technical support center at the enterprise to the resolution of the user's inquiry. When a human support agent's intervention is necessary to address the user's concern, the AI co-browse agent may also be used to enhance the human support agent's effectiveness in assisting the user. For example, the AI co-browse agent may provide a real-time co-browse view that includes a simulated version of the user's interface as well as the human support agent's view on the latter's screen. The AI co-browse agent may mask sensitive information on the human agent's screen. These features may help the human agent in assisting the user to resolve the latter's inquiry.

Provided are systems and methods for resolving technical support issues. The technical support issues may arise when a user uses a digital portal to access an account held with an enterprise. A system may include an AI co-browse agent. The AI co-browse agent may be used to assist with resolving technical support issues received at a technical support center of the enterprise. The system may include a real-time co-browse simulator. The AI co-browse agent may include the real-time co-browse simulator. The real-time co-browse simulator may run using a Gen AI system. Said real-time co-browse simulator may be a component of the AI co-browse agent. A technical support issue may include an issue or difficulty that the user faces. The technical support issue may be resolved when a technical support center helps the user by using a co-browse session.

The AI co-browse agent may be configured to receive a request for a co-browse session at the technical support center of the enterprise from the user, said co-browse session to be conducted between the AI co-browse agent and the user to resolve the technical support issue. The co-browse session may include a first display that is provided to the AI co-browse agent. The first display may include a user view of the digital portal and a simulated view of the user view of the digital portal. The co-browse session may include a second display that is provided to the user as a graphical user interface (“GUI”) on the device of the user. The GUI may include the user view of the digital portal and the simulated view of the user view of the digital portal.

The AI co-browse agent may have read-write privileges to the simulated view and read-only privileges to the user view. The user has read-write privileges to the user view and read-only privileges to the simulated view. Read-write privileges may include where the user or the AI co-browse agent have permission to both view (read) and modify (write) the contents of a view. Therefore, they can see and change information from that view. Read-only privilege may include where the user or the AI co-browse agent can only view and access information within a view, but cannot make any changes, edits, or deletions to it. Therefore, they can see information from that view, but they may not change it. Read-only privileges may enhance security and/or integrity of the contents of the view by preventing accidental modifications and unauthorized data alterations.

The AI co-browse agent may be configured to determine a sensitivity level for each piece of sensitive information appearing on a screen of a device of the user when the user is logged onto the digital portal to access an account held with the enterprise. The AI co-browse agent may be configured to obtain a predetermined authorization level for the co-browse agent and mask pieces of sensitive information that have sensitivity levels that are above the predetermined authorization level for the co-browse agent.

The AI co-browse agent may be configured to establish the co-browse session between a device of the user and the AI co-browse agent. The AI co-browse agent may be configured to demonstrate a series of steps on the first display in the simulated view for the user to take to resolve the technical support issue.

The real-time co-browse simulator is configured to synchronize actions of the user with actions of the AI co-browse agent. The synchronization may include where, as the AI co-browse agent demonstrates each step of the series of steps on the first display in the simulated view, the real-time co-browse simulator ensures the following. It may ensure that each step of the series of steps appears on the GUI in the simulated view. It may ensure that the user completes each step of the series of steps on the second display in the user view before a next step is presented to the user on the second display in the simulated view. It may ensure that as the user completes each step of the series of steps on the second display in the user view, the first display in the user view is automatically updated.

The AI co-browse agent may be configured to terminate the co-browse session when the technical support issue is resolved.

The system may further include where movements of the AI co-browse agent and of the user are monitored by document object model (“DOM”). The movement may include scrolling and clicking. The movement information from the DOM may assist the real-time co-browse simulator in synchronizing actions of the user with actions of the AI co-browse agent.

The system may further include where the user presents the technical support issue by phone, by email, or by chatbot. The user's device may include a mobile device or a tablet computer, and the digital portal is a mobile portal. The user's device may include a tablet computer, a laptop computer, or a desktop computer, and the digital portal is an online portal.

The system may further include where, when the screen of the user comprises the GUI and other items, said AI co-browse agent is configured to mask pieces of sensitive information that are found on the GUI and the other items.

The systems and methods described herein are illustrative. Systems and methods in accordance with this disclosure will now be described in connection with the figures, which form a part hereof. The figures show illustrative features of systems and methods in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments, such as systems and/or methods, may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

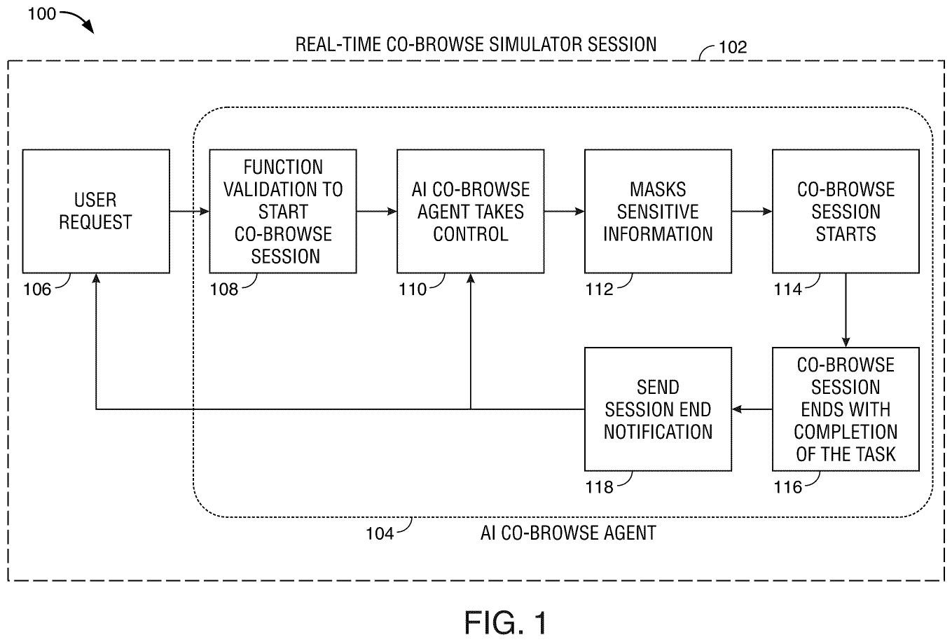

FIG. 1 shows illustrative block diagram 100. Block diagram 100 may include a system for conducting a real-time Gen AI based co-browse simulator session, also referred to as a real-time co-browse simulator session 102. AI co-browse agent 104 may receive user request 106 using a digital portal such as a mobile portal or an online portal to address a technical support issue. The request may be to conduct a real-time co-browse simulator session to address the technical support issue. The AI co-browse agent may address user request 106 with an end-to-end solution. The end-to-end solution may include some or all relevant steps from initiation to resolution of addressing the technical support issue requested by the user. AI co-browse agent 104 may use natural language processing (“NLP”) to comprehend user request 106.

After comprehending user request 106, such as by using NLP, AI co-browse agent 104 may perform function validation to start co-browse session 108. Function validation may determine if the real-time co-browse simulator session 102 possesses the functionality to address user request 106.

If the functionality is available for real-time co-browse simulator session 102, AI co-browse agent 104 may then take control 110 to address user request 106. AI co-browse agent 104 may mask sensitive information 112. With the sensitive information masked, AI co-browse agent 104 may start co-browse session 114. The co-browse session may create a GUI showing the user view and the simulator view on the user's screen. The co-browse session may create a similar presentation on a real or conceptual screen of the AI co-browse agent. The co-browse session may utilize real-time co-view simulator session 102 to synchronize the co-browse session on the user's GUI and the AI co-browse agent's presentation.

AI co-browse agent 104 may proceed during the co-browse session to guide the user to resolve the query by projecting the user's view of the portal and a simulated view of the user's view of the portal onto a real or conceptual screen of the AI co-browse agent and a real screen of the user. AI co-browse agent 104 may manipulate the simulated view of the user's view and the user may manipulate the user's view. The co-browse view lets each party see the actions of the other party. Synchronization by using real-time co-view simulation session 102 may facilitate the two parties staying closely aligned with each other. This arrangement may enable AI co-browse agent 104 to lead the user through steps needed to address user request 106.

Co-browse session may end with completion of the technical support issue at 116. AI co-browse agent 104 may send session end notification at 118. The session end notification may be sent to the user at 106. The session end notification may be sent to the AI co-browse agent at 110.

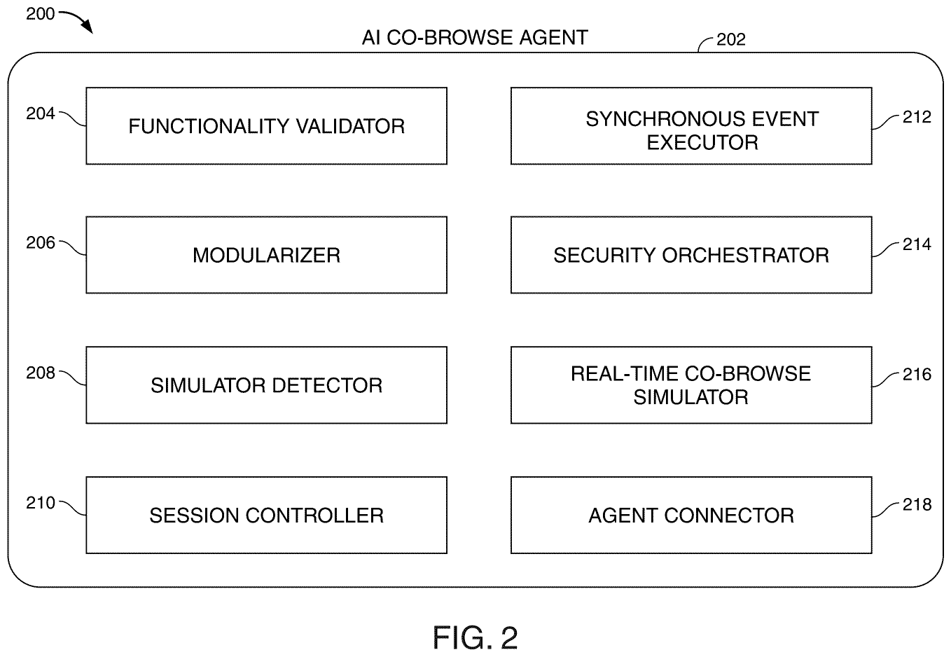

FIG. 2 shows illustrative block diagram 200. Block diagram 200 may provide an illustrative diagram featuring the components of AI co-browse agent 202. A user may seek assistance from the AI co-browse agent 202 to overcome a problem the user has encountered relating to the use of a digital portal of an enterprise. The problem may include overcoming a difficulty that the user encounters in using the digital portal such as using a mobile portal or an online portal. The technical support issue may include a difficulty in which the mobile portal or online portal may be used to overcome.

Functionality validator 204 may ensure that a request from the user for a co-browse session to address a technical support issue may be handled by the AI co-browser agent 202. Factors in making this determination may include information about the user and the user's account, the complexity of the request, among other factors. If the request can be handled, the AI co-browse agent 202 may proceed to the next step. If not, the user may be transferred to a human agent to handle the user's request.

Modularizer 206 may break large components within a service provided by AI co-browse agent 202 into smaller modules to avoid the dependency loops, such as software dependency loops, and to facilitate synchronization. A software dependency loop may include a situation where two or more components and/or steps depend on each other in a cycle. Modularizer 206 may also assist in reducing latency during the runtime of the AI co-browse agent from high latency to moderate latency, or from high latency to low latency. Modularizer 206 may reduce latency from 100 milliseconds (ms) or more to less than 100 ms. Modularizer 206 may reduce latency from 100 milliseconds (ms) or more to 50 ms or less. High latency may be considered 100 ms or greater. Moderate latency may be considered between 50 ms and 100 ms. Low latency may be considered 50 ms or less.

Simulator Detector 208 may check the availability and/or confirm the availability of simulator modules to run a real-time co-browse simulator session to assist the user with a co-browse session. If simulator modules are available, then the real-time co-browse simulator may proceed with a co-browse session. If not, the user may be transferred to a human agent to handle the request.

When moving ahead with a co-browse session, Session Controller 210 may control the start and stop of the co-browse session between the user and AI co-browse agent 202. Session Controller 210 may send a request to the user to initiate a co-browse session. If the user accepts the request, the session may commence. If the request is denied, the user may be transferred to a human agent to address the needs of the user.

When the user selects to initiate the co-browse session, and the session begins, Synchronous Event Executor 212 may ensure real-time synchronization of actions between AI co-browse agent 202 and the user. The user and AI co-browse agent 202 may share the same view of a mobile portal or an online portal of the users with the enterprise. Synchronous Event Executor 212 may track actions such as scrolling and clicking, using, for example, a Document Object Model (“DOM”). DOM may capture movements of the user such as scrolling and clicking and document these movements. The DOM may be used to assist in synchronizing the user with the AI co-browse agent 202. DOM may provide the AI co-browse agent 202 with confirmation that the user has replicated recommended actions. Synchronous Event Executor 212 may ensure that the browser views of both the AI co-browse agent 202 and the user are in sync with each other. If the user and AI co-browse agent 202 become out of sync, then the user may miss steps that the AI co-browse is performing, which may cause latency between the two. Latency may delay implementation by the user of the solution provided by the AI co-browse agent.

To protect sensitive information of the user from exposure to AI co-browse agent 202, Security orchestrator 214 may redact and/or mask the sensitive information. Redacting and/or masking information that is sensitive to the user may also prevent or limit data leakage. Data leakage may include an unintentional exposure of sensitive information, like personal details or business secrets, to unauthorized entity. Leaked information may include sensitive information that is accidentally exposed to a party outside of its intended secure environment. Redacting and/or masking may block the AI co-browse agent's access to sensitive information. This may also provide protection against data leakage. Sensitive information may also be blocked on the user's screen such as the view of the co-browser of AI co-browse agent 202 on the user's screen.

Real-time co-browse simulator 216 may ensure that the co-browse view projected onto the actual or conceptual screen of AI co-browse agent 202 and the screen of the user remains synchronized. The co-browse view may include a view of the actual screen of the user and a simulated view of AI co-browse agent 202. Sensitive information may be redacted and/or masked on the screen of AI co-browse agent 202 and/or the screen of the user. By presenting co-browse views that are synchronized and redacted and/or masked, the user can effectively and safely address technical support issues by entering a co-browse session.

Agent Connector 218 may connect AI Co-browse Agent 202 with the user. Agent Connection 218 may connect the two parties to begin the co-browse session between AI Co-browse Agent and the user.

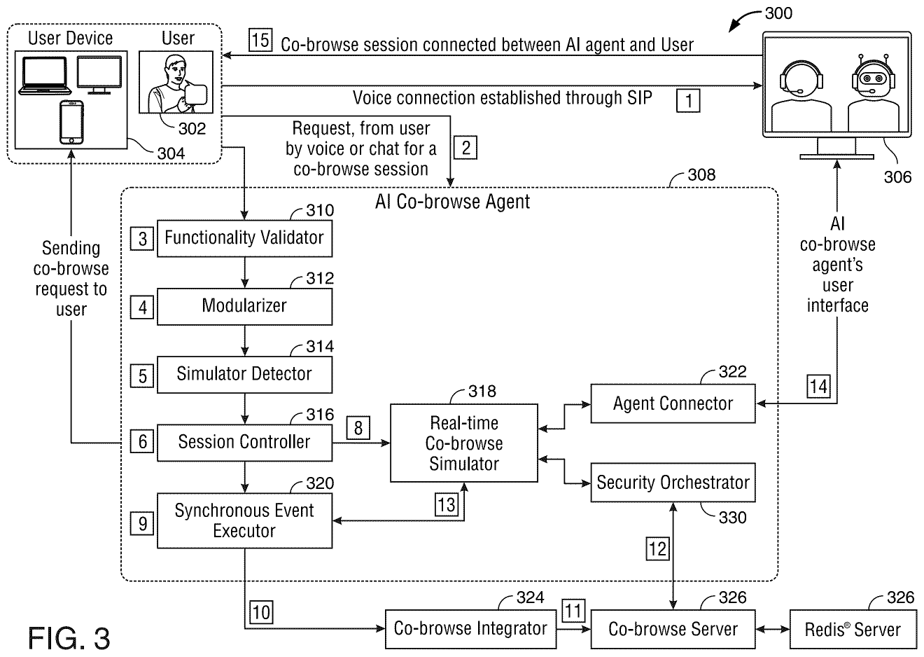

FIG. 3 shows an illustrative flow diagram 300. Flow diagram 300 may provide an illustrative diagram featuring the progression of a co-browse session. User 302 may log onto a digital portal such as a mobile portal or an online portal. The portals may be portals supplied by an enterprise where the user has an account. User 302 may use user device 304 to access the mobile portal or online portal. User device 304 may include a mobile device such as a smartphone, a tablet computer, a laptop computer, and a desktop computer.

At step 1, user 302 may contact the AI co-browse agent user interface 306, either through device 304 or through a voice call. The voice connection may be established though session initiation protocol (“SIP”). SIP may include a standard protocol that allows users to start, manage, and end communication sessions over the internet. SIP may be used for voice calls, video conferences, and instant messaging. Once a connection is established, either through user device 304 or through a voice call, user 302 may be given an option of requesting a co-browse session with AI co-browse agent 308 through AI co-browse agent's user interface 306. AI co-browse agent's user interface 306 may be a chatbot. The chatbot may include AI co-browse agent's user interface 306. The chatbot may be separate from AI co-browse agent's user interface 306. AI co-browse agent's user interface 306 may be a human support agent.

At step 2, user 302 may request a co-browse session with AI co-browse agent 308. At step 3, AI co-browse agent 308 may initiate an internal analysis of the feasibility of a co-browse session. The internal analysis by AI co-browse agent 308 may begin at step 3 by using functional validator 310 to identify the request from user 302 and determine the request may be handled in a co-browser session by AI co-browse agent 308. At step 4, once ascertaining that the request may be handled by the co-browser session using AI co-browse agent 308, modularizer 312 may break up the request from user 302 into smaller modules to avoid dependency loops, such as software dependency loops, and facilitate synchronization. A software dependency loop may include a situation where two or more components and/or steps depend on each other in a cycle. At step 5, simulator detector 314 may check the user's request with the simulator modules to confirm the latter's availability.

At step 6, session controller 316 may initiate a co-browse session request to user device 304 of user 302. At step 7, user 302 may be offered an invitation to join a co-browse session. At step 8, once user 302 accepts the co-browse invitation received at device 304, session controller 316 may initiate real-time co-browse simulator 318. Real-time co-browse simulator 318 may create a user co-browse view to appear on both device 304 and AI co-browse agent user interface 306. Real-time co-browse simulator 318 may ensure that both user 302 and AI co-browse agent user interface 306 show the same content.

At step 9, synchronous event executor 320 may ensure that the screens and actions are synchronous on both the user side on user device 304 and the agent side on AI co-browse agent user interface 306. At step 10, synchronous event executor 320 may be in electronic communication with co-browse integrator 324. The latter may facilitate the simulation of the co-browse session on device 304 and AI co-browse agent user interface 306 by considering specifics about the user use case.

At step 11, co-browse integrator 324 may achieve its purpose by accessing information from Redis® Server 328 using Co-browse Server 326. Redis Server 328 may include functionality as a memory storage server used for quick response. Redis Server 328 may include an open-source, in-memory data structure store often used as a cache or message broker. At step 12, security orchestrator 330 may interact with co-browser server 326. Security orchestrator 330 may also interact with real-time co-browse simulator 318 to mask the user's sensitive information.

At step 13, synchronous event executor 320 may be in electronic communication with real-time co-browse simulator 318 to assist each in performing their functions. At step 14, real-time co-browse simulator 318 may be connected to the AI co-browse agent user interface 306 by agent connector 322. At step 14, real-time co-browse simulator 318 may be connected to the AI co-browse agent's user interface 306 by agent connector 322. At step 15, a co-browse session may be initiated by connecting user 302 and AI Co-browse agent user interface 306. At step 15, AI co-browse agent's user interface 306 may be a chatbot. The chatbot may include AI co-browse agent's user interface 306. The chatbot may be separate from AI co-browse agent's user interface 306.

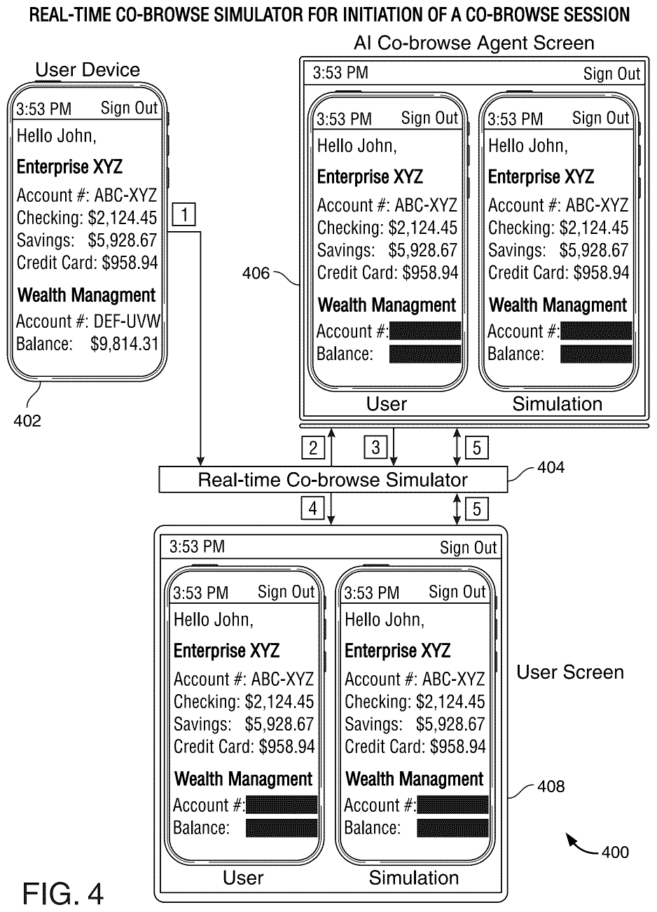

FIG. 4 shows an illustrative flow diagram 400. Flow diagram 400 may provide an illustrative diagram featuring the progression of a real-time co-browse simulator for initiation of a co-browse session. The flow may start with user device 402. User device 402 may include, for example, a mobile device such as a smartphone, tablet computer, desktop computer, and laptop computer. User device 402 may present access to a user's account with an enterprise by a digital portal such as a mobile portal or an online portal. The mobile device and tablet computer may access the user's account using the mobile portal. The desktop computer, laptop computer, and tablet computer may access the user's account using the online portal.

In the current example, user device 402 may be a mobile device and may access the user's account using a mobile portal. User device 402 may show different accounts with an enterprise such as Enterprise XYZ. Account ABC-XYZ may include balances for a savings sub-account, a checking sub-account, and a credit card sub-account. A wealth management account DEF-UVW may also be presented along with a balance for that account.

At step 1, the user may request a co-browse session with real-time co-browse simulator 404 to resolve an issue that the user faces. Real-time co-browse simulator 404 may run using Gen AI. At step 2, real-time co-browse simulator 404 may create a user view on AI co-browse agent screen 406. Real-time co-browse simulator 404 may redact or mask sensitive information. In the current example, the wealth management account number and balance are masked. The reason for this may include that the AI co-browse agent may only have access privilege to account information such as savings balance, checking balance, and credit card balance. Letting the AI co-browse agent view the wealth management account number and balance would be granting more access that the AI co-browse agent is entitled to.

In the current example, AI Co-browse Agent Screen 406 may show a user view that includes the user's mobile portal, with sensitive information masked. AI Co-browse Agent Screen 406 may show a simulated view that may be a representation of the user's view of their mobile portal that includes masking of sensitive information. The simulation may be manipulated by the AI co-browse agent.

At step 3, AI co-browse agent screen 406 may initiate a co-browse session through real-time co-browse simulator 404. AI co-browse agent screen 406 includes the real-time co-browse simulator 404, among other functionalities. At step 4, real-time co-browse simulator 404 may then facilitate presentation of the views found in AI co-browse agent screen 406 to also be presented on user screen 408. Presentation on user screen 408 may enable the establishment of the co-browse session between the user and the AI co-browse agent.

At step 5, the user and the AI co-browse agent may engage in a co-browse session. The AI co-browse agent may manipulate the simulation view on the AI co-browse agent screen 406. The simulated view on user screen 408 may reflect changes to the simulated view by the AI co-browse agent on the AI co-browse agent screen 406. The user may replicate the demonstrated changes by making changes to the user view on user screen 408. When the user makes changes to the user view on user screen 408, the user's changes may be visible on the user view on the AI co-browse agent screen. This iterative process that includes the AI co-browse agent making changes that are demonstrated and incorporated by the user may continue until the user's initial request is resolved.

Since the user is using a mobile device, the co-browse view may be presented on the mobile device. The user may be able to manipulate the user's mobile device portal that is presented in the co-browse view on user screen 408. The user may copy actions presented on the simulated view presented on user screen 408. The AI co-browse agent may be able to manipulate the simulated view on the AI co-browse screen 406. The user may see the actions of the AI co-browse agent on the simulated view on user screen 406. This way, the user may receive demonstrated instructions from the AI co-browse agent in a synchronized manner while the user's sensitive information is redacted and/or masked from the AI co-browse agent.

The real-time co-browse simulator may be able to present the same or similar co-browse view on a mobile device of the user and the desktop computer of the AI co-browse agent. The real-time co-browse simulator may be able to present the same or similar co-browse view on the desktop computer of the user and the conceptual screen of the AI co-browse agent. Many other possibilities and iterations for presenting the co-browse view may also exist and are included in this disclosure.

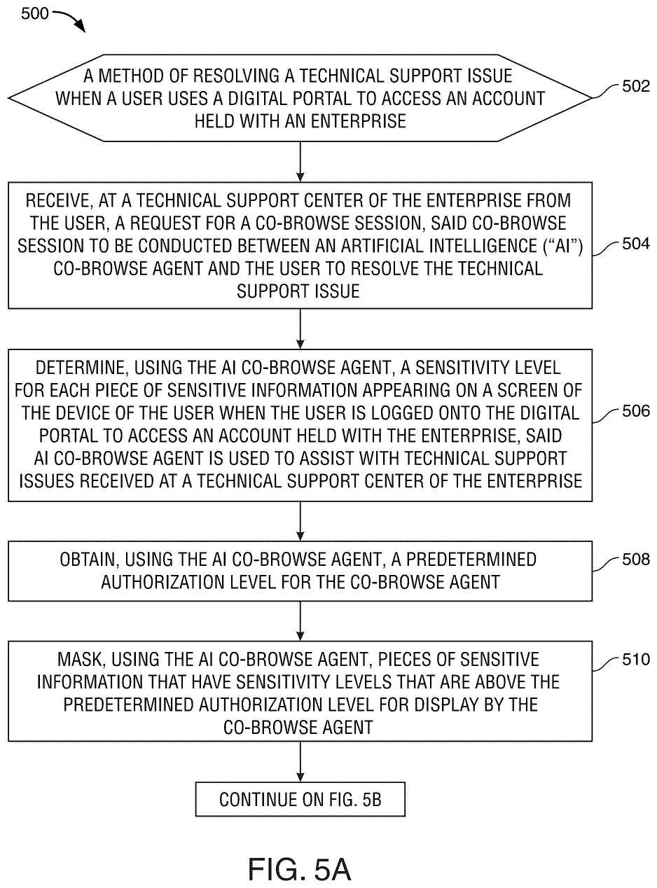

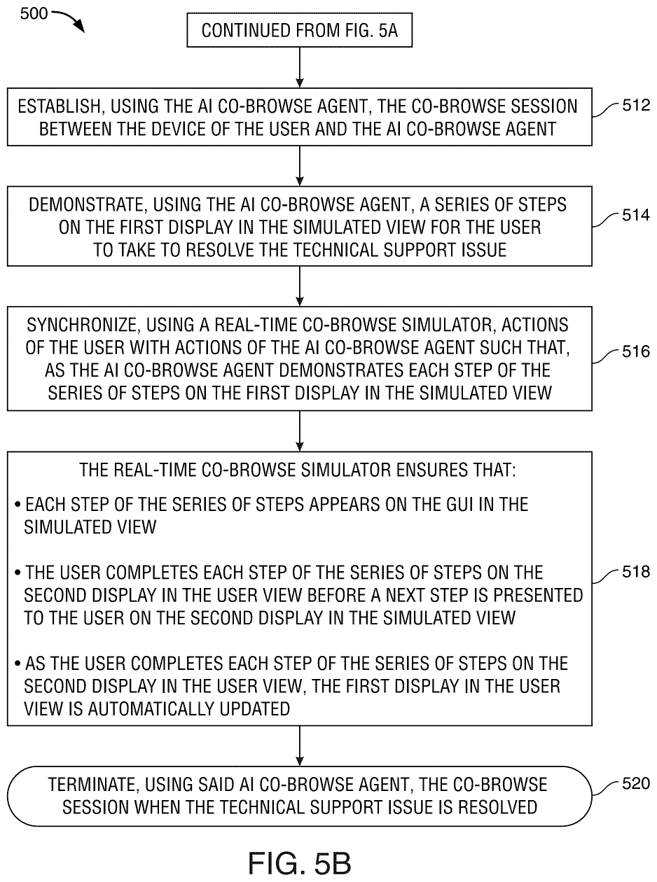

FIG. 5A shows, starting at step 502, an illustrative flowchart of a method of resolving a technical support issue when a user uses a digital portal to access an account held with an enterprise. At step 504, receive, at a technical support center of the enterprise from the user, a request for a co-browse session, said co-browse session to be conducted between an AI co-browse agent and the user to resolve the technical support issue. At step 506, determine, using the AI co-browse agent, a sensitivity level for each piece of sensitive information appearing on a screen of the device of the user when the user is logged onto the digital portal to access an account held with the enterprise, said AI co-browse agent is used to assist with technical support issues received at a technical support center of the enterprise.

At step 508, obtain, using the AI co-browse agent, a predetermined authorization level for the co-browse agent. At step 510, mask, using the AI co-browse agent, pieces of sensitive information that have sensitivity levels that are above the predetermined authorization level for display by the co-browse agent. The method continues in FIG. 5B with step 512.

FIG. 5B shows an illustrative flowchart that continues from FIG. 5A, step 510. At step 512, establish, using the AI co-browse agent, the co-browse session between the device of the user and the AI co-browse agent. At step 514, demonstrate, using the AI co-browse agent, a series of steps on the first display in the simulated view for the user to take to resolve the technical support issue. At step 516, synchronize, using a real-time co-browse simulator, actions of the user with actions of the AI co-browse agent such that, as the AI co-browse agent demonstrates each step of the series of steps on the first display in the simulated view.

At step 518, the real-time co-browse simulator ensures that: each step of the series of steps appears on the GUI in the simulated view; the user completes each step of the series of steps on the second display in the user view before a next step is presented to the user on the second display in the simulated view; and as the user completes each step of the series of steps on the second display in the user view, the first display in the user view is automatically updated. At step 520, terminate, using said AI co-browse agent, the co-browse session when the technical support issue is resolved.

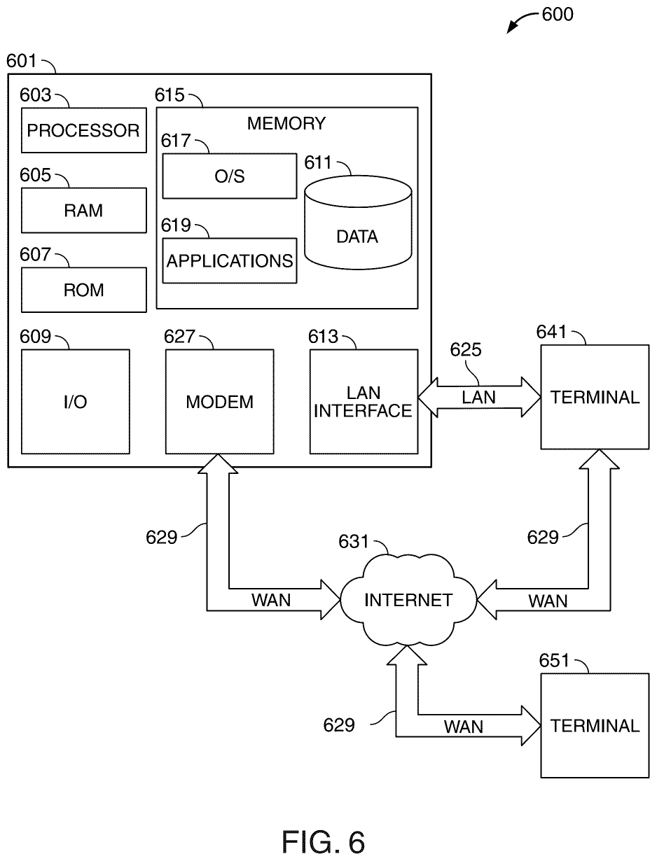

FIG. 6 shows an illustrative block diagram of system 600 that includes computer 601. Computer 601 may alternatively be referred to herein as an “engine,” “server” or a “computing device.” Computer 601 may be a workstation, desktop, laptop, tablet, smartphone, or any other suitable computing device. Elements of system 600, including computer 601, may be used to implement various aspects of the systems and methods disclosed herein, including those shown in FIGS. 1-5. Each of the systems, methods, and algorithms illustrated in FIGS. 1-5 may include some or all the elements of system 600.

Computer 601 may have a processor 603, including a central processing unit (“CPU”), for controlling the operation of the device and its associated components, and may include RAM 605, ROM 607, input/output (“I/O”) 609, and a non-transitory or non-volatile memory 615. Machine-readable memory may be configured to store information in machine-readable data structures. Processor 603 may also execute all software running on the computer. Other components, such as graphics processing unit (“GPU”), EEPROM, Flash memory, neural-network processing elements, or any other suitable components, may also be part of the computer 601.

Memory 615 may be comprised of any suitable permanent storage technology, such as a hard drive. Memory 615 may store software including the operating system 617 and application program(s) 619 along with any data 611 needed for the operation of system 600. Memory 615 may also store videos, text, and/or audio assistance files. The data stored in memory 615 may also be stored in cache memory, or any other suitable memory.

I/O module 609 may include connectivity to a microphone, keyboard, touch screen, mouse, and/or stylus through which input may be provided into computer 601. The input may include input relating to cursor movement. The input/output module may also include one or more speakers for providing audio output and a video display device for providing textual, audio, audiovisual, and/or graphical output. The input and output may be related to computer application functionality.

System 600 may be connected to other systems via a local area network interface 613. System 600 may operate in a networked environment supporting connections to one or more remote computers, such as terminals 641 and 651. Terminals 641 and 651 may be personal computers or servers that include many, or all the elements described above relative to system 600. The network connections depicted in FIG. 6 include a local area network (“LAN”) 625 and a wide area network (“WAN”) 629 but may also include other networks. When used in a LAN networking environment, computer 601 is connected to LAN 625 through LAN interface 613 or an adapter. When used in a WAN networking environment, computer 601 may include a modem 627 or other means for establishing communications over WAN 629, such as Internet 631.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration to permit retrieval of data from a web-based server or an API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 619, which may be used by computer 601, may include computer executable instructions for invoking functionality related to communication, such as e-mail, Short Message Service (“SMS”), and voice input and speech recognition applications. Application program(s) 619 (which may be alternatively referred to herein as “plugins,” “applications,” or “apps”) may include computer executable instructions for invoking functionality related to performing various tasks. Application program(s) 619 may utilize one or more algorithms that process receive executable instructions, perform power management routines or other suitable tasks.

Application program(s) 619 may include computer executable instructions (alternatively referred to as “programs”). The computer executable instructions may be embodied in hardware or firmware (not shown). Computer 601 may execute the instructions embodied by the application program(s) 619 to perform various functions.

Application program(s) 619 may utilize the computer-executable instructions executed by a processor. Programs may include routines, programs, objects, components, data structures, and the like, which perform tasks or implement abstract data types. A computing system may be operational with distributed computing environments. Tasks may be performed by remote processing devices that are linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Any information described above in connection with data 611, and any other suitable information, may be stored in memory 615.

The disclosure may be described in the context of computer-executable instructions, such as application(s) 619, being executed by a computer. Programs may include routines, programs, objects, components, data structures, and the like, which perform tasks or implement data types. The computer-executable instructions may be located on one or more non-transitory computer-readable media. The computer-executable instructions, when executed by processor 603, may be used to implement various aspects of the systems and methods disclosed herein.

The disclosure may also be practiced in distributed computing environments. Tasks may be performed by remote processing devices that are linked through a communications network. A communications network may include a computer network. In a distributed computing environment, programs may be in both local and remote computer storage media including memory storage devices. It should be noted that such programs may be considered for the purposes of this application as engines with respect to the performance of the tasks to which the programs are assigned.

Computer 601 and/or terminals 641 and 651 may also include various other components, such as a battery, speaker, and/or antennas (not shown). Components of computer system 601 may be linked by a system bus, wirelessly or by other suitable interconnections. Components of computer system 601 may be present on one or more circuit boards. In some embodiments, the components may be integrated into a single chip. The chip may be silicon-based.

Terminal 641 and/or terminal 651 may be portable devices such as a laptop, cell phone, tablet, smartphone, or any other computing system for receiving, storing, transmitting, and/or displaying relevant information. Terminal 641 and/or terminal 651 may be one or more user devices. Terminals 641 and 651 may be identical to system 600 or different. Differences may be related to hardware components and/or software components.

The disclosure may be operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, tablets, mobile phones, smartphones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

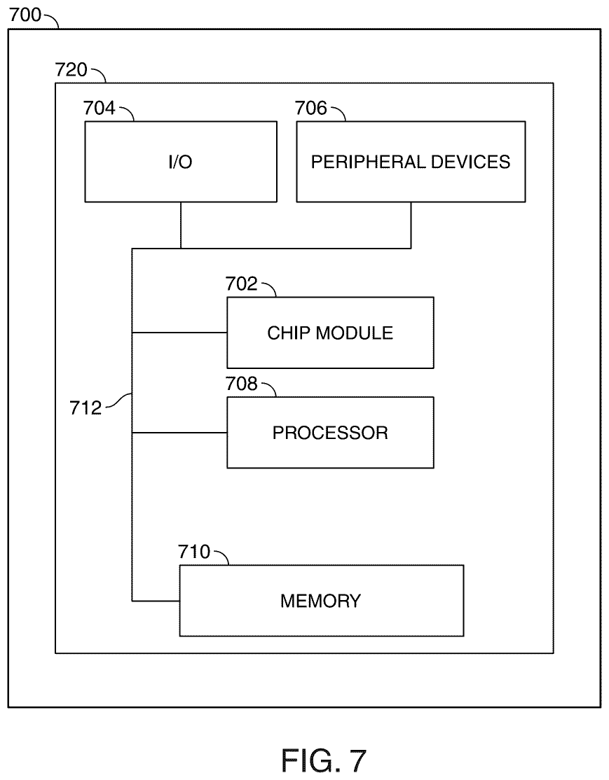

FIG. 7 shows an illustrative system 700 that may be configured in accordance with the principles of the disclosure. System 700 may be a computing device. System 700 may include one or more features of the apparatus shown in FIGS. 1-6. System 700 may include chip module 702, that may include one or more integrated circuits, and that may include logic configured to perform any other suitable logical operations.

System 700 may include one or more of the following components: I/O circuitry 704, that may include a transmitter device and a receiver device and may interface with fiber optic cable, coaxial cable, telephone lines, wireless devices, PHY layer hardware, a keypad/display control device or any other suitable media or devices; peripheral devices 706, that may include counter timers, real-time timers, power-on reset generators or any other suitable peripheral devices; logical processing device 708, that may compute data structural information and structural parameters of the data; and machine-readable memory 710.

Machine-readable memory 710 may be configured to store in machine-readable data structures: machine executable instructions, (which may be alternatively referred to herein as “computer instructions” or “computer code”), applications such as applications 619 (shown in FIG. 6), signals, and/or any other suitable information or data structures.

A system bus or other interconnections 712 may couple components 702, 704, 706, 708 and 710 and may be present on one or more circuit boards such as circuit board 720. In some embodiments, a single chip may integrate the components. The chip may be silicon-based.

Elements of system 700, including circuit board 720 and various coupled components found on circuit board 730, may be used to implement various aspects of the systems and methods disclosed herein, including those shown in FIGS. 1-6. Each of the systems and methods illustrated in FIGS. 1-6 may include some or all the elements of system 700.

Thus, provided may include systems and methods relating to resolving technical support issues by establishing a co-browse session with the user using a real-time co-browse simulator. People skilled in the art will appreciate that the present invention can be practiced by other than the described embodiments, which are presented for purposes of illustration rather than of limitation. The present invention is limited only by the claims that follow.

What is claimed is:

1. A system for resolution of a technical support issue when a user uses a digital portal to access an account held with an enterprise, the system comprising:
an artificial intelligence (“AI”) co-browse agent, said AI co-browse agent is used to assist with technical support issues received at a technical support center of the enterprise;
a real-time co-browse simulator, said real-time co-browse simulator is run using generative (“Gen”) AI, and said real-time co-browse simulator is a component of the AI co-browse agent;
said AI co-browse agent is configured to:
receive a request for a co-browse session at the technical support center of the enterprise from the user, said co-browse session to be conducted between the AI co-browse agent and the user to resolve the technical support issue, and said co-browse session comprising:
a first display is provided to the AI co-browse agent, said first display comprising a user view of the digital portal and a simulated view of the user view of the digital portal; and
a second display is provided to the user as a graphical user interface (“GUI”) on a device of the user, said GUI comprising the user view of the digital portal and the simulated view of the user view of the digital portal;
wherein:
the AI co-browse agent has read-write privileges to the simulated view and read-only privileges to the user view; and
the user has read-write privileges to the user view and read-only privileges to the simulated view;
determine a sensitivity level for each piece of sensitive information appearing on a screen of the device of the user when the user is logged onto the digital portal to access an account held with the enterprise;
obtain a predetermined authorization level for the co-browse agent;
mask pieces of sensitive information that have sensitivity levels that are above the predetermined authorization level for display by the co-browse agent;
establish the co-browse session between the device of the user and the AI co-browse agent;
demonstrate a series of steps on the first display in the simulated view for the user to take to resolve the technical support issue;
said real-time co-browse simulator is configured to:
synchronize actions of the user with actions of the AI co-browse agent such that, as the AI co-browse agent demonstrates each step of the series of steps on the first display in the simulated view, the real-time co-browse simulator ensures that:
each step of the series of steps appears on the GUI in the simulated view;
the user completes each step of the series of steps on the second display in the user view before a next step is presented to the user on the second display in the simulated view; and
as the user completes each step of the series of steps on the second display in the user view, the first display in the user view is automatically updated; and
said AI co-browse agent is configured to terminate the co-browse session when the technical support issue is resolved.

2. The system of claim 1 wherein movements of the AI co-browse agent in the first display and of the user in the second display are monitored by document object model (“DOM”), said movements comprise scrolling and clicking, and information from the DOM is used to assist in synchronizing actions of the user with actions of the AI co-browse agent.

3. The system of claim 1 wherein the user presents the technical support issue by phone, by email, or by chatbot.

4. The system of claim 1 wherein the device of the user comprises a mobile device or a tablet computer, and the digital portal is a mobile portal.

5. The system of claim 1 wherein the device of the user comprises a tablet computer, a laptop computer, or a desktop computer, and the digital portal is an online portal.

6. The system of claim 1 wherein, when the screen of the user comprises the GUI and other items, said AI co-browse agent is configured to mask pieces of sensitive information that are found on the GUI and the other items.

7. The system of claim 1 wherein the technical support issue comprises a technical issue the user encounters when using the digital portal of the enterprise or an issue whose solution involves using the digital portal.

8. A method of resolving a technical support issue when a user uses a digital portal to access an account held with an enterprise, the method comprising:
receiving, at a technical support center of the enterprise from the user, a request for a co-browse session, said co-browse session to be conducted between an artificial intelligence (“AI”) co-browse agent and the user to resolve the technical support issue, and said co-browse session comprising:
a first display is provided to the AI co-browse agent, said first display comprising a user view of the digital portal and a simulated view of the user view of the digital portal; and
a second display is provided to the user as a graphical user interface (“GUI”) on a device of the user, said GUI comprising the user view of the digital portal and the simulated view of the user view of the digital portal;
wherein:
the AI co-browse agent has read-write privileges to the simulated view and read-only privileges to the user view; and
the user has read-write privileges to the user view and read-only privileges to the simulated view;
determining, using the AI co-browse agent, a sensitivity level for each piece of sensitive information appearing on a screen of the device of the user when the user is logged onto the digital portal to access an account held with the enterprise, said AI co-browse agent is used to assist with technical support issues received at a technical support center of the enterprise;
obtaining, using the AI co-browse agent, a predetermined authorization level for the co-browse agent;
masking, using the AI co-browse agent, pieces of sensitive information that have sensitivity levels that are above the predetermined authorization level for display by the co-browse agent;
establishing, using the AI co-browse agent, the co-browse session between the device of the user and the AI co-browse agent;
demonstrating, using the AI co-browse agent, a series of steps on the first display in the simulated view for the user to take to resolve the technical support issue;
synchronizing, using a real-time co-browse simulator, actions of the user with actions of the AI co-browse agent such that, as the AI co-browse agent demonstrates each step of the series of steps on the first display in the simulated view, the real-time co-browse simulator ensures that:
each step of the series of steps appears on the GUI in the simulated view;
the user completes each step of the series of steps on the second display in the user view before a next step is presented to the user on the second display in the simulated view; and
as the user completes each step of the series of steps on the second display in the user view, the first display in the user view is automatically updated;
wherein said real-time co-browse simulator is run using generative (“Gen”) AI, and said real-time co-browse simulator is a component of the AI co-browse agent; and
terminating, using said AI co-browse agent, the co-browse session when the technical support issue is resolved.

9. The method of claim 8 wherein movements of the AI co-browse agent in the first display and of the user in the second display are monitored by document object model (“DOM”), said movements comprise scrolling and clicking, and information from the DOM is used to assist in synchronizing actions of the user with actions of the AI co-browse agent.

10. The method of claim 8 wherein the user presents the technical support issue by phone, by email, or by chatbot.

11. The method of claim 8 wherein the device of the user comprises a mobile device or a tablet computer, and the digital portal is a mobile portal.

12. The method of claim 8 wherein the device of the user comprises a tablet computer, a laptop computer, or a desktop computer, and the digital portal is an online portal.

13. The method of claim 8 wherein, when the screen of the user comprises the GUI and other items, said AI co-browse agent is configured to mask pieces of sensitive information that are found on the GUI and the other items.

14. The method of claim 8 wherein the technical support issue comprises a technical issue the user encounters when using the digital portal of the enterprise or an issue whose solution involves using the digital portal.

15. A system for resolution of a technical support issue when a user uses a digital portal to access an account held with an enterprise, the system comprising:
an artificial intelligence (“AI”) co-browse agent, said AI co-browse agent is used to assist with technical support issues received at a technical support center of the enterprise;
a real-time co-browse simulator, said real-time co-browse simulator is run using generative (“Gen”) AI, and said real-time co-browse simulator is a component of the AI co-browse agent;
said AI co-browse agent is configured to:
receive a request for a co-browse session at the technical support center of the enterprise from the user, said co-browse session to be conducted between the AI co-browse agent and the user to resolve the technical support issue, said technical support issue presented to the AI co-browse agent from the user by phone, by email, or by chatbot, and said co-browse session comprising:
a first display is provided to the AI co-browse agent, said first display comprising a user view of the digital portal and a simulated view of the user view of the digital portal; and
a second display is provided to the user as a graphical user interface (“GUI”) on a device of the user, said GUI comprising the user view of the digital portal and the simulated view of the user view of the digital portal;
wherein:
the AI co-browse agent has read-write privileges to the simulated view and read-only privileges to the user view; and
the user has read-write privileges to the user view and read-only privileges to the simulated view;
determine a sensitivity level for each piece of sensitive information appearing on a screen of the device of the user when the user is logged onto the digital portal to access an account held with the enterprise;
obtain a predetermined authorization level for the co-browse agent;
mask pieces of sensitive information that have sensitivity levels that are above the predetermined authorization level for display by the co-browse agent;
establish the co-browse session between the device of the user and the AI co-browse agent;
demonstrate a series of steps on the first display in the simulated view for the user to take to resolve the technical support issue;
said real-time co-browse simulator is configured to:
synchronize actions of the user with actions of the AI co-browse agent such that, as the AI co-browse agent demonstrates each step of the series of steps on the first display in the simulated view, the real-time co-browse simulator ensures that:
each step of the series of steps appears on the GUI in the simulated view;
the user completes each step of the series of steps on the second display in the user view before a next step is presented to the user on the second display in the simulated view; and
as the user completes each step of the series of steps on the second display in the user view, the first display in the user view is automatically updated; and
synchronize actions of the user with actions of the AI co-browse agent by monitoring movements of the AI co-browse agent in the first display and of the user in the second display using document object model (“DOM”), said movements comprise scrolling and clicking;
said AI co-browse agent is configured to terminate the co-browse session when the technical support issue is resolved.

16. The system of claim 15 wherein the device of the user comprises a mobile device or a tablet computer, and the digital portal is a mobile portal.

17. The system of claim 15 wherein the device of the user comprises a tablet computer, a laptop computer, or a desktop computer, and the digital portal is an online portal.

18. The system of claim 15 wherein, when the screen of the user comprises the GUI and other items, said AI co-browse agent is configured to mask pieces of sensitive information that are found on the GUI and the other items.

19. The system of claim 15 wherein the technical support issue comprises a technical issue the user encounters when using the digital portal of the enterprise or an issue whose solution involves using the digital portal.
